(19) United States
(12) Patent Application Publication
(10) Pub. No.: US 2026/0005891 A1
(43) Pub. Date: Jan. 1, 2026

(54) MULTI-TIER OPTIMIZED INGRESS REPLICATION FOR ETHERNET VIRTUAL PRIVATE NETWORKS

(71) Applicant: Cisco Technology, Inc., San Jose, CA (US)

(72) Inventors: Satya R Mohanty, San Ramon, CA (US); Mankamana Prasad Mishra, San Jose, CA (US); Ali Sajassi, Alamo, CA (US)

(21) Appl. No.: 18/758,001

(22) Filed: Jun. 28, 2024

(51) Int. Cl. H04L 12/18; H04L 12/44; H04L 49/1515

(52) U.S. Cl. CPC H04L 12/1886; H04L 12/44; H04L 49/1515

(57) ABSTRACT

In one aspect, a method includes defining a corresponding depth for each leaf device and each spine device in a leaf-spine network fabric having a hierarchical structure; defining one or more zones in the leaf-spine network fabric; generating a corresponding replication list for each leaf device and one or more spine devices in the leaf-spine network fabric based at least in part of the corresponding depth and the one or more zones defined; and performing ingress replication of network traffic received at a given leaf device using the corresponding replication list of the given leaf device and the corresponding replication list of at least one of the one or more spine devices.

### BACKGROUND

Network Virtualization Overlay networks using Ethernet Virtual Private Network (EVPN) as their control plane may use Ingress Replication or PIM (Protocol Independent Multicast)-based trees to convey the overlay Broadcast, Unknown unicast and Multicast (BUM) traffic. PIM provides a solution to avoid sending multiple copies of the same packet over the same physical link. Ingress replication avoids the dependency on PIM in the Network Virtualization Overlay network core.

Existing ingress replication solutions suffer from (1) limitations on the spine-leaf structure in which they are deployed (1 or two layers at max), (2) requiring manual configuration, and (3) the amount of information stored in a spine node since bridge domain is provisioned in spine too, resulting in the need for storing of unnecessary information.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example structure of a leaf-spine EVPN topology, according to some aspects of the present disclosure;

FIG. 2 is a non-limiting example of topology of FIG. 1 with example zones and depths defined, according to some aspects of the present disclosure;

FIG. 3A illustrates an example EVPN IMET route's Network Layer Reachability Information format, according to some aspects of the present disclosure;

FIG. 3B illustrates an example Provider Multicast Service Interface's format, according to some aspects of the present disclosure;

FIG. 4 is an example visual representation of control plane designation of upstream/downstream replicator designations and BUM tunnel setup, according to some aspects of the present disclosure;

FIGS. 5A-D visually illustrates upstream and downstream replication of BUM traffic in a leaf-spine topology based on optimized ingress replication techniques described herein, according to some aspects of the present disclosure;

FIG. 6 illustrates an example method of optimized ingress replication, according to some aspects of the present disclosure; and

FIG. 7 shows an example computing system according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### OVERVIEW

One or more aspects of the present disclosure are directed to optimizing multi-layered ingress replication in overlay network deployments having a spine-leaf structure. The techniques disclosed herein are applicable CLOS network topology and Massive Scale Data Center (MSDC) deployments. More particularly, the techniques disclosed herein optimize the amount of information that a network replicator may carry by, among others, defining flood zones and depth for spine/replicator nodes in a given network topology, enhancing Inclusive Multicast Ethernet Tag (IMET) routes to carry depth and zone information, and designating upstream and downstream replicator selection.

In one aspect, a method includes defining a corresponding depth for each leaf device and each spine device in a leaf-spine network fabric having a hierarchical structure; defining one or more zones in the leaf-spine network fabric; generating a corresponding replication list for each leaf device and one or more spine devices in the leaf-spine network fabric based at least in part of the corresponding depth and the one or more zones defined; and performing ingress replication of network traffic received at a given leaf device using the corresponding replication list of the given leaf device and the corresponding replication list of at least one of the one or more spine devices.

In another aspect, the leaf-spine network fabric is a CLOS network.

In another aspect, performing the ingress replication includes upstream replication of the network traffic to a first spine device having the corresponding depth that is one level higher than the corresponding depth of the given leaf device, the first spine device being one of the one or more spine devices.

In another aspect, the ingress replication includes downstream replication of the network traffic, by the first spine device, to one or more additional leaf devices that are in a same zone of the one or more zones as the given leaf device.

In another aspect, the ingress replication includes upstream replication of the network traffic, by the first spine device, to a second spine device having the corresponding depth that is one level higher that the corresponding depth of the first spine device, and the second spine device performs downstream replication of the network traffic to at least one third spine device with the corresponding depth one level lower that the corresponding depth of the second spine device, each of the at least one third spine device being in a different one of the one or more zones than the given leaf device.

In another aspect, the upstream replication of the network traffic is repeated until the network traffic reaches at least one spine device with the corresponding depth having a highest value, with each receiving spine device performing a corresponding downstream replication to different zones of the one or more zones than a zone assigned to the given leaf device.

In another aspect, the network traffic is Broadcast, Unknown Unicast, and Multicast (BUM) traffic.

In one aspect, a network device includes one or more memories having computer-readable instructions stored therein; and one or more processors. The one or more processors are configured to execute the computer-readable instructions to define a corresponding depth for each leaf device and each spine device in a leaf-spine network fabric having a hierarchical structure; define one or more zones in the leaf-spine network fabric; generate a corresponding replication list for each leaf device and one or more spine devices in the leaf-spine network fabric based at least in part of the corresponding depth and the one or more zones defined; and perform ingress replication of network traffic received at a given leaf device using the corresponding replication list of the given leaf device and the corresponding replication list of at least one of the one or more spine devices.

In one aspect, one or more non-transitory computer-readable media include computer-readable instructions, which when executed by one or more processors, cause the one or more processors to define a corresponding depth for each leaf device and each spine device in a leaf-spine network fabric having a hierarchical structure; define one or more zones in the leaf-spine network fabric; generate a corresponding replication list for each leaf device and one or more spine devices in the leaf-spine network fabric based at least in part of the corresponding depth and the one or more zones defined; and perform ingress replication of network traffic received at a given leaf device using the corresponding replication list of the given leaf device and the corresponding replication list of at least one of the one or more spine devices.

### EXAMPLE EMBODIMENTS

As noted above, ingress replication in the context of EVPNs suffers from several deficiencies including, but not limited to, (1) limitations on the spine-leaf structure in which they are deployed (1 or two layers at max), (2) requiring manual configuration, and (3) the amount of information stored in a spine node since bridge domain is provisioned in spine too, resulting in the need for storing of unnecessary information.

Moreover, currently only the highest spine node acts as a replicator of network traffic to other nodes in a leaf-spine topology. Therefore, any leaf node sends traffic to the spine node at the top of the hierarchy and the spine node replicates the traffic to all leaf nodes in the network where the same bridge domain is hosted.

One or more aspects of the present disclosure are directed to optimizing multi-layered ingress replication in overlay network deployments having a spine-leaf structure. The techniques disclosed herein are applicable CLOS network topology and Massive Scale Data Center (MSDC) deployments. As will be described further, a generic mechanism is introduced where multiple replicators may be designated and positioned in a multi-tier leaf-spine network topology. The disclosed techniques reduce overhead from a replicator so that none of the unicast processing is performed and that a replicator only functions as a replicator.

Below, a number of terminologies and corresponding abbreviations are introduced, which will be referenced throughout the specification.

### Terminology

Closed Loop Optimal Solution (CLOS): A CLOS network may also be referred to as a CLOS fabric, CLOS topology, etc.

Bridge Domain (BD) or Medium Access Control (MAC) Virtual Routing and Forwarding (VRF): BD or MAC VRF, where forwarding occurs based on a MAC table lookup.

Broadcast, Unknown Unicast, Multicast (BUM) Traffic. Default Behavior for these packets are to be flooded in layer-2 domain.

EVPN Service: Control-plane based mechanism to provide layer-2 stretch.

EVPN type 2: MAC/(Internet Protocol) Border Gateway Protocol (IP BGP) route in EVPN address family. It is originated from any leaf once a new host is learnt. It is propagated across all the network which is hosting EVPN service for given bridge domain so that layer-2 forwarding can be optimized (Instead of treating as unknown MAC address)

EVPN Type 3/Inclusive Multicast Ethernet Tag (IMET) route: BGP based route which is originated by each node that is hosting an EVPN service for a given BD. It carries information as what tunnel to use to carry BUM traffic and how to setup the tunnels.

Replicator: Spine, Super Spine, or super supper spine which has been provisioned to perform point to multi point replication. These nodes would be referred to as replicators.

Depth for replicator: Each node where EVPN service is being configured would also be provisioned with depth. Depth may start at depth 0, where each leaf is and would increment by one at each intermediary level in a leaf-spine topology (e.g., a CLOS network) towards one or more super spines.

Split Horizon: In the context of EVPN information, split horizon enables a node to determine to not send back traffic to same segment where it got originated.

Node/Device: In this disclosure a leaf device may also be referred to as a leaf node or simply a leaf. Similarly a spine node may also be referred to as a spine node or simply a spine.

A CLOS network, also known as a CLOS fabric or CLOS topology, refers to a specific type of network architecture characterized by a multi-stage, non-blocking switching fabric. It typically consists of multiple layers of switches arranged in a hierarchical manner, with each layer connected to every switch in the adjacent layers. CLOS networks are often used in data centers and large-scale networks due to their scalability, high bandwidth, and fault tolerance.

EVPN is a network virtualization technology used to provide Layer 2 and Layer 3 VPN services over an IP/Multi-Protocol Label Switching (MPLS) backbone network. EVPN can enable the extension of Layer 2 Ethernet services across Layer 3 (IP) networks, allowing for the creation of virtualized network segments or VPNs. EVPN uses BGP as the control plane protocol to distribute MAC (Media Access Control) and IP routing information across the network.

While CLOS networks provide the underlying physical infrastructure for network connectivity, EVPN overlays can be implemented on top of this infrastructure to provide advanced networking services such as Layer 2 and Layer 3 VPNs, network segmentation, and multi-tenancy.

In some network architectures, EVPN overlays may be deployed within a CLOS fabric to provide connectivity and services to different segments of the network, such as between data center sites or within a large-scale enterprise network. However, they are not inherently the same thing; rather, EVPN can be used as a technology within a CLOS network to enhance its capabilities.

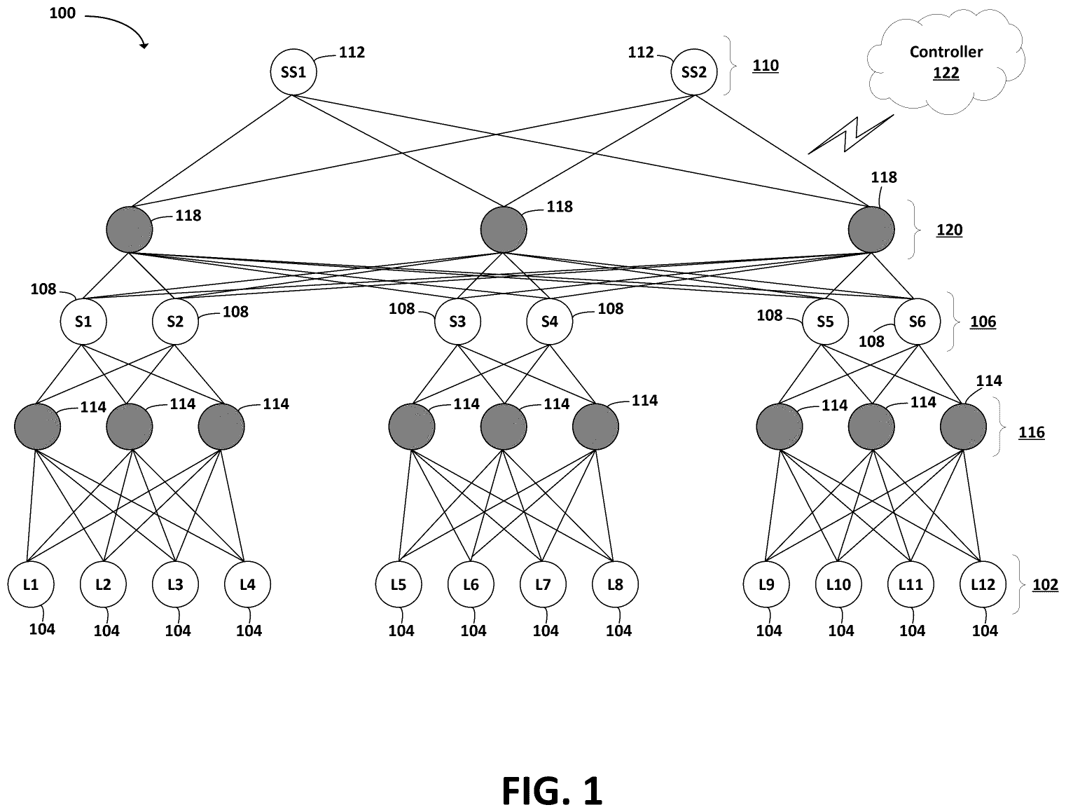

FIG. 1 illustrates an example structure of a leaf-spine EVPN topology, according to some aspects of the present disclosure.

Topology 100 is an example CLOS network. In topology 100 includes a leaf layer 102 with leaf devices 104 (e.g., L1-L12 in non-limiting example of FIG. 1). Each of leaf devices 104 may be any known or be developed switching/routing device. In a given network, end devices, compute devices, virtual machines, etc., may be connected to any given one or more of leaf devices 104 under a defined BD.

Topology 100 further includes an intermediary layer such as spine layer 106 with spine devices 108 (e.g., S1-S5). Each of spine devices 108 may be configured as inline route reflector for BGP. Each of spine devices 108 may be any known or to be developed switching/routing device.

Topology 100 further includes an example super spine layer 110. Super spine layer 110 may include one or more Super Spine (SS) nodes such as super spine devices 112 (e.g., SS1 and SS2). Each of super spine devices 112 may be any known or to be developed switching/routing device.

Topology 100 further includes a number of inline Route Reflectors (RR) associated with each of spine devices 108 (shown as inline route reflectors 114 at layer 116) and each of super spine devices 112 (shown as inline route reflectors 118 at layer 120).

In some examples, massive scale architectures such as MSDCs can have the same or similar design as topology 100 of FIG. 1.

While the solution described herein is described with reference to CLOS networks, the present disclosure is not limited thereto and the solution can be extended to distributed random topologies. In that instance, a controller having an end-to-end network visibility may be used to visualize and provision role of a replicator in a network. Accordingly, to cover such scenarios, controller 122 is also shown in FIG. 1. Controller 122 may be a cloud-based controller or on-premise. Controller 122 may be an enterprise network controller that is communicatively coupled (wired or wireless) to an enterprise network including a network having topology 100. Accordingly, controller 122 may have a network-wide visibility to determine network replicators, provision leaf and spine devices as described below, and overall enable, implement, and manage optimized ingress replication techniques described herein.

Hereinafter, a series of steps/processes for optimizing ingress replication of BUM traffic in the context of non-limiting example of FIG. 1 will be described.

Initially, EVPN services may be provisioned on leaf devices 104, spine devices 108 and super spine devices 112.

For instance, each of leaf devices 104 may be provisioned with an EVPN instance. which can be a BD or a MAC VRF configuration. In example of FIG. 1, each of leaf devices 104 may be participating in a BD denoted by an EVPN Identifier (EVI) having a value 100 (e.g., Bridge Domain, EVI 100)

Each of spine devices 108 and super spine devices 112 may also be provisioned with the same EVPN instance. Furthermore, each of spine devices 108 and super spine devices 112 expected to function as a replicator, may also carry a designation for doing so (e.g., Bridge Domain, EVI 100 as replicator only).

One leaf and spine/super spine devices are provisioned appropriately, depths and zones for topology 100 may be defined.

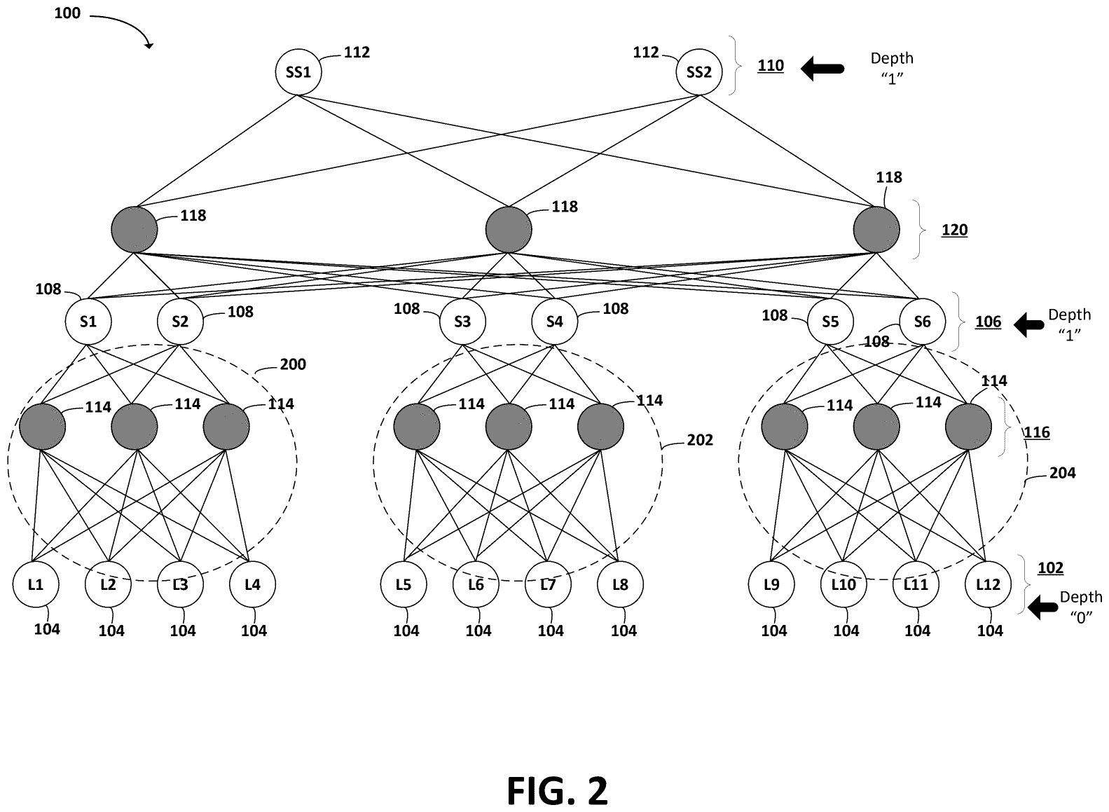

FIG. 2 is a non-limiting example of topology of FIG. 1 with example zones and depths defined, according to some aspects of the present disclosure. Topology 100 is a 3-layered non-limiting example topology formed of leaf layer 102, spine layer 106 and super spine layer 110. As shown in FIG. 2, leaf devices 104 in leaf layer 102 may be assigned a “depth 0,” spine devices 108 in spine layer 106 may be assigned a “depth 1,” and super spine devices 112 in super spine layer 110 may be assigned a “depth 2.” This example depth assignment can be generated to include depth 0 to depth ‘n’, where ‘n’ is the number of layers of a given topology such as topology 100.

Furthermore, FIG. 2 shows that 3 example zones including zone 200, zone 202, and zone 204 are defined for spines designated as replicators (e.g., for {S1, S2}, for {S3, S4}, and/or for {S5, S6}. Each zone may define the scope of corresponding replicator(s) (e.g., inline route reflectors 114) at a given depth.

In a CLOS network, a replicator and a leaf are point to point BGP sessions. In that case every node that is a direct BGP peer would be in same zone.

Each spine and/or super spine device that is provisioned as a replicator, will also be provisioned with a depth value (e.g., depth 1 or depth 2 shown in FIG. 2) while each of leaf devices 104 may be provisioned with depth 0. This provisioning may be manual or via a controller.

Some spine devices are connected to leaf devices (e.g., spine devices 108 are connected to leaf devices 104). Spine/leaf architectures may generally be set up such that spine devices are configured as RRs and are direct BGP peer to one or more leaf devices in certain geographical area. In this case each direct BGP peer towards a leaf device is going to have a single flood zone. For instance, in topology 100, {S1, S2} may be flooding only to zone 200 (direct BGP peers) and not to remaining remote peers such as leaf devices in zone 202 and/or zone 204 (which may have been learnt via other route reflectors in network) will not be part of a flood zone.

As shown in FIG. 2, some spine devices may only be connected to other spine devices/replicators (e.g., super spine devices 112) both on southbound and north bound (this would be the case for topologies having a depth higher than ‘2’). In the example of topology 100 of FIG. 2, super spine devices 112 (SS1 and SS2) can flood to all available spines on southbound (e.g., spine devices 108). Doing so may result in duplicate traffic reaching many of spine devices 108. Accordingly, each of super spine devices 112 may run any known or to be developed algorithm (e.g., Weighted Highest Random Weight (HRW)) in order to ensure that at any given time only one of super spine devices 112 is serving spine devices 108 on the southbound.

With initial provisioning of leaf and spine devices as well as definition of zones and depths described, enhancements to IMET EVPN route to carry zone and depth information for optimizing ingress replication of BUM traffic will be described next.

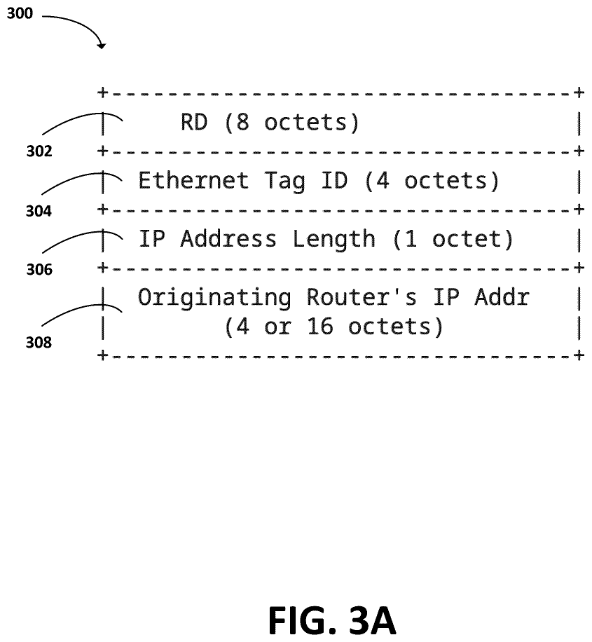

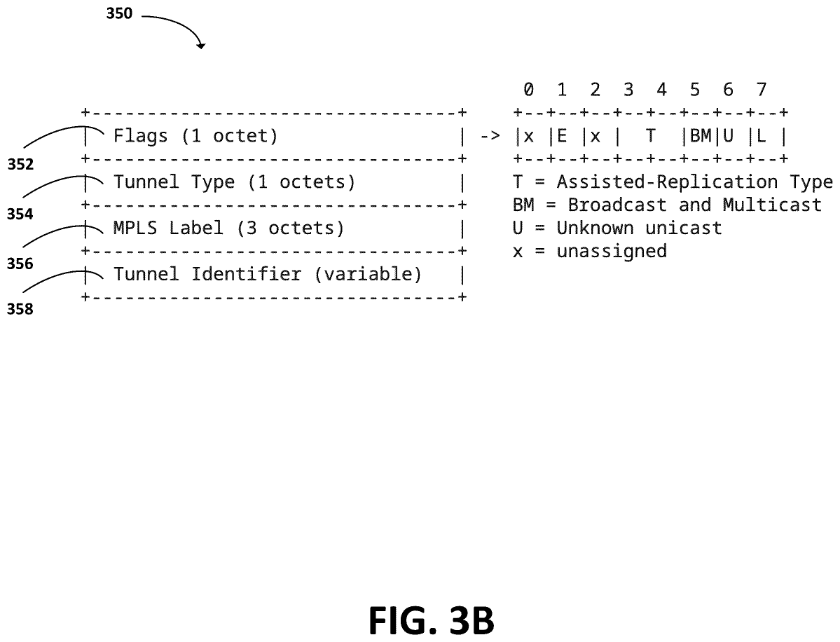

FIG. 3A illustrates an example EVPN IMET route's Network Layer Reachability Information format, according to some aspects of the present disclosure. Example IMET Network Layer Reachability Information (NLRI) format 300 can include Route Distinguisher 302 (8 octets), Ethernet Tag ID 304 (4 octets), IP Address Length 306 (1 octet), and Originating Router's IP Address 308 (4 or 16 octets).

FIG. 3B illustrates an example Provider Multicast Service Interface's format, according to some aspects of the present disclosure. Example format 350 can include flags 352 (1 octet), tunnel type 354 (1 octet), MPLS label 356 (3 octet), and tunnel identifier 358 (of variable size).

As shown in FIG. 3B, flags 352 may have 8 bits where the Extension flag (E) and the Leaf Information Required (L) Flag are already allocated (bits 1 and 7 shown in FIG. 3B), bits 3 and 4 together form assisted replication type (T) that defines the AR role for the advertising router, bit 5 is the Broadcast and Multicast (BM) flag, and bit 6 is the Unknown (U) flag. Bits 5 and 6 may collectively be referred to as Pruned-Flood Lists (PFL) flags.

As shown in FIG. 3B, bits 0 and 2 remain unassigned. One or both may be used to add zone and depth information, as described above. As noted, both depth and zone information may be encoded in one extended community (e.g., bit 0 or 2) or each of bits 0 and 2 may be assigned one or the other of depth and zone information.

Alternatively, an additional extended community may be added to format 300 and/or format 350 of FIGS. 3A and 3B to include a generic language may be used to include depth and zone information without having to describe how one or more bits may be encoded to carry such information.

Control plane procedures for upstream/downstream replicator designation and BUM tunnel setup for carrying depth and zone information will be described next. In the context of the present disclosure, upstream may refer to traffic movement in a hierarchical leaf-spine network topology (e.g., CLOS topology such as topology 100 of FIG. 1) northbound de from leaf devices towards the highest super spine node. Similarly, downstream may refer to traffic movement in a hierarchical leaf-spine network topology (e.g., CLOS topology such as topology 100 of FIG. 1) southbound from super spine devices to intermediary spine devices at lower depths and ultimately toward leaf devices.

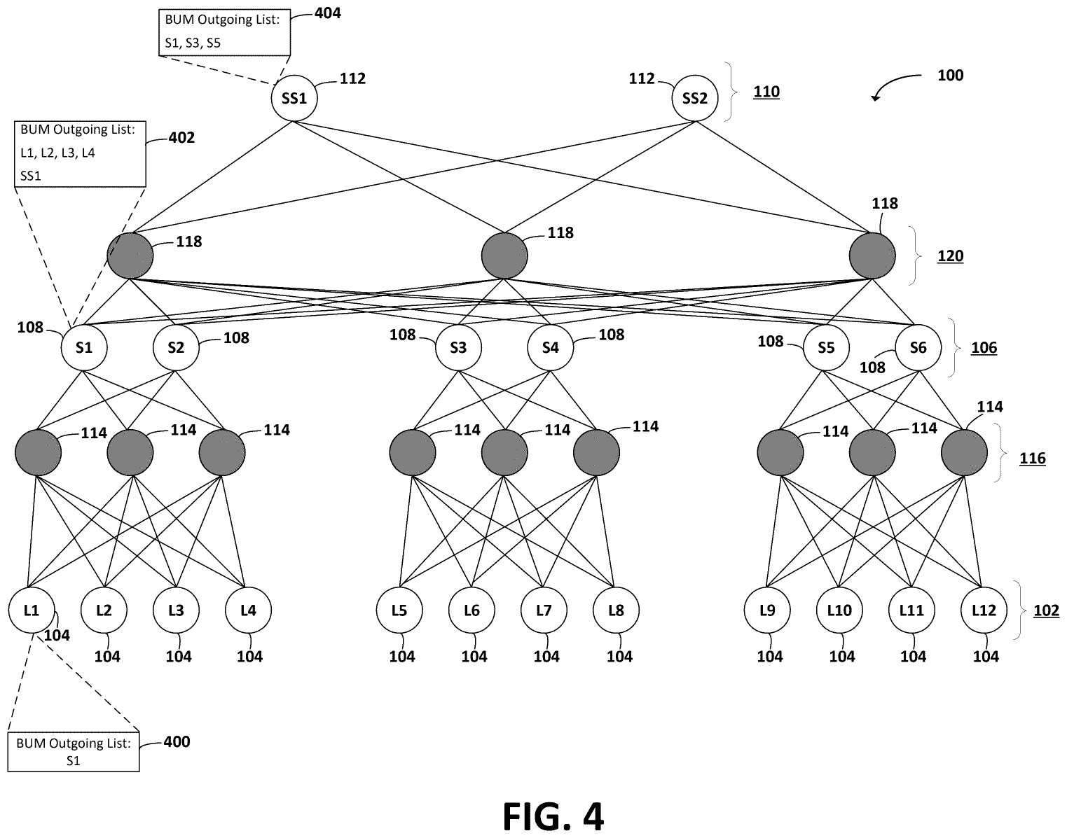

FIG. 4 is an example visual representation of control plane designation of upstream/downstream replicator designations and BUM tunnel setup, according to some aspects of the present disclosure.

In some examples, a leaf device such as any one of leaf devices 104 may be configured with upstream replicator designation. Similarly, any replicator node at depths lower than the highest designated depth may similarly be configured with designation of an upstream replicator.

For instance, FIG. 4 shows replication list 400 for L1 as an example of leaf devices 104. Replication list 400 includes a BUM outgoing list for L1. In selecting an upstream replicator, L1 has two options to choose, namely S1 and S2 (two of spine devices 108). In one example, L1 may use a hashing processing (e.g., modulo based or IP address-based hashing) to select one of S1 or S2 as the designated upstream replicator. In another example, L1 may select the upstream replicator with the highest IP or IGP metric. In this example, such upstream replicator selection process may result in L1 selecting S1 as the upstream replicator, as shown in replication list 400. With this designation, any BUM traffic received at L1, from network devices connected to L1, is sent to S1.

S1 may perform a similar process as L1 to select one of SS1 and SS2 (super spine devices 112) as the upstream replicator. As shown per replication list 402, S1 may select SS1 as the upstream replicator. In addition, S1 may also determine a downstream flood list (e.g., L1, L2, L3, and L4) as shown in replication list 402.

Spine devices at higher depths (e.g., SS1 and SS2 in topology 100), may need to perform downstream replicator designation. For instance, S1-S6 are downstream replicators to both SS2 and SS2, with each of zone 200, zone 202, and zone 204 having a pair of spine devices (e.g., {S1, S2} for zone 200, {S3, S4} for zone 202, and {S5, S6} for zone 204).

In one example, SS1 and SS2 are provisioned to ensure that while sending traffic back to different zones, traffic is not forwarded to multiple replicators in same zone. For instance, traffic destined for zone 200, need not be sent to both spine devices S1 and S2. To do so, each of SS1 and SS2 may select one spine device at the next lower depth to send downstream traffic to. In topology 100, SS1 may select S1 for zone 200, S3 for zone 202, and S5 for zone 204 as the designated downstream replicator. This is shown in replication list 404.

Replication list 400, replication list 402, and replication list 404 may be constructed by each respective leaf or spine device using depth and zone information provided in the IMET route tag as described above.

In example above, replication lists are built from L1 to SS1. L1 selects S1 as its designated replicator and programs the hardware to forward any BUM traffic to S1. S1 performs a similar process to build replication list 402 to forward traffic to downstream leaf devices and one copy of received BUM traffic to next level replicator (e.g., SS1). S1 may also apply split horizon procedure to ensure that downstream traffic received from L1 is not propagated back to L1. Similarly, SS1 may also perform split horizon procedure to ensure that traffic is not sent back to zone from which the traffic is originated (e.g., traffic from zone 200 is not flooded back to zone 200).

While building corresponding replication lists at each level is described with reference to L1, S1, and SS1 only, the present disclosure is not limited thereto. A similar list, using the same process as described above, may be used to build replication lists for every leaf device, every spine device, and every super spine device of topology 100.

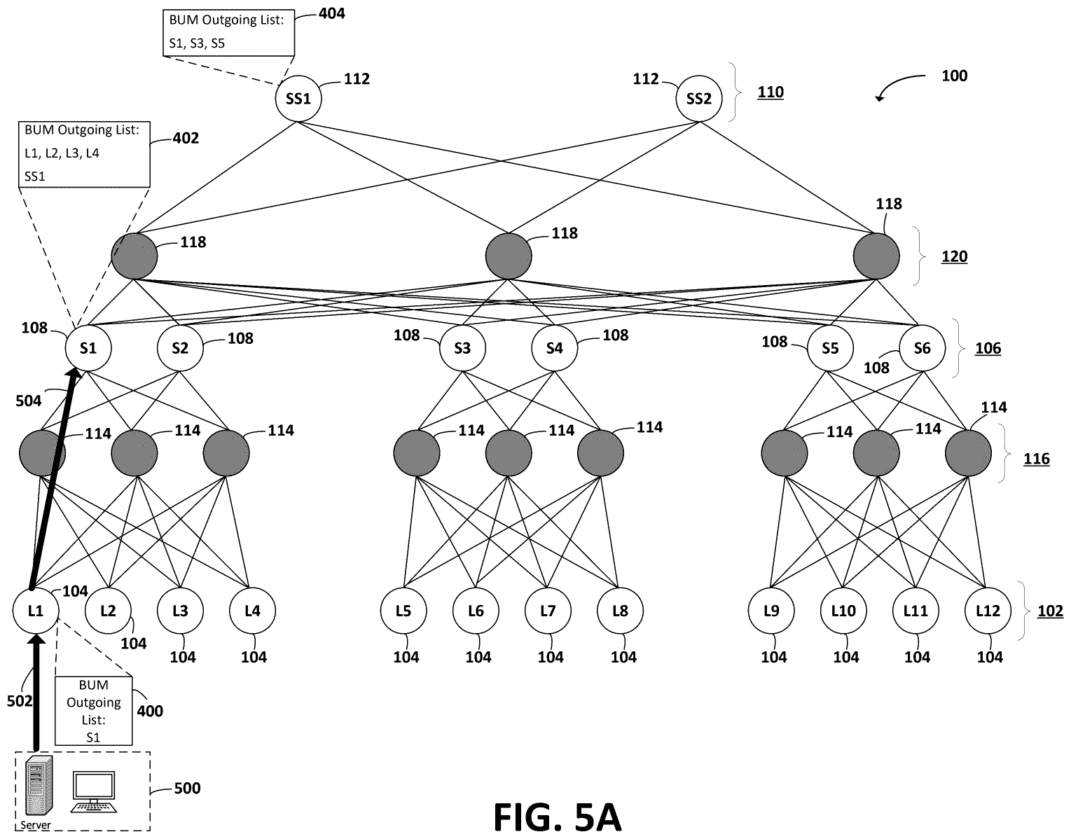

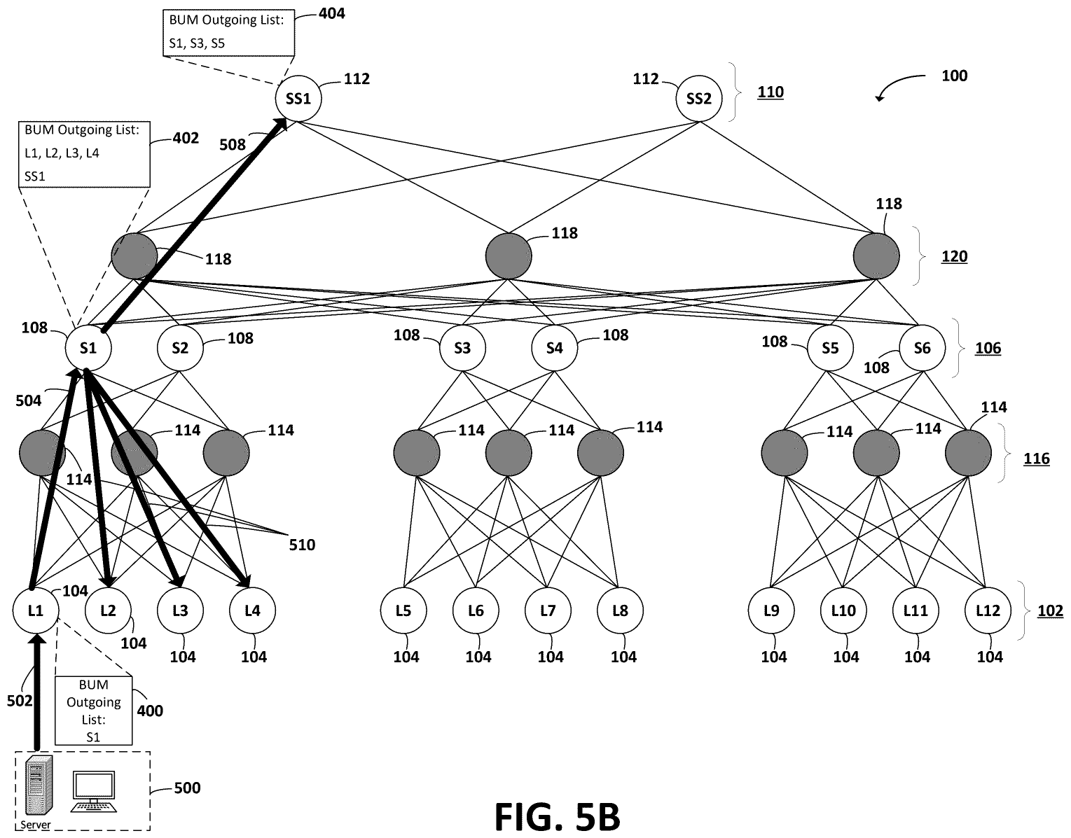

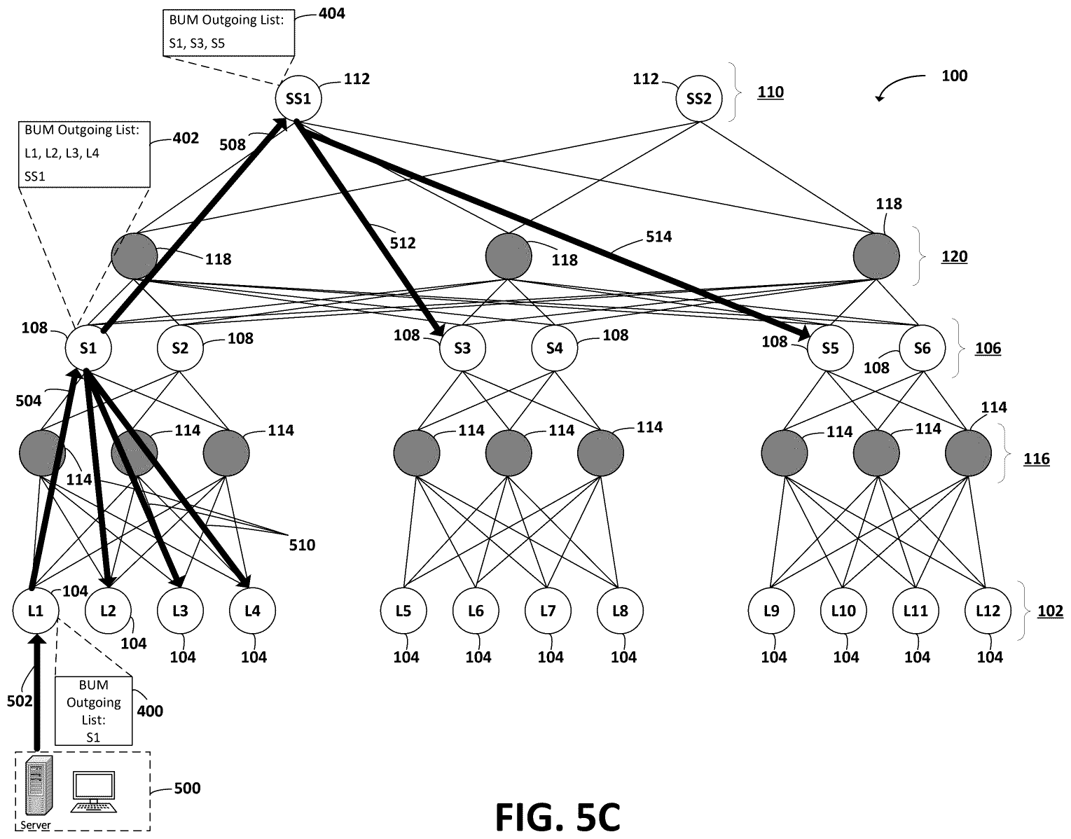

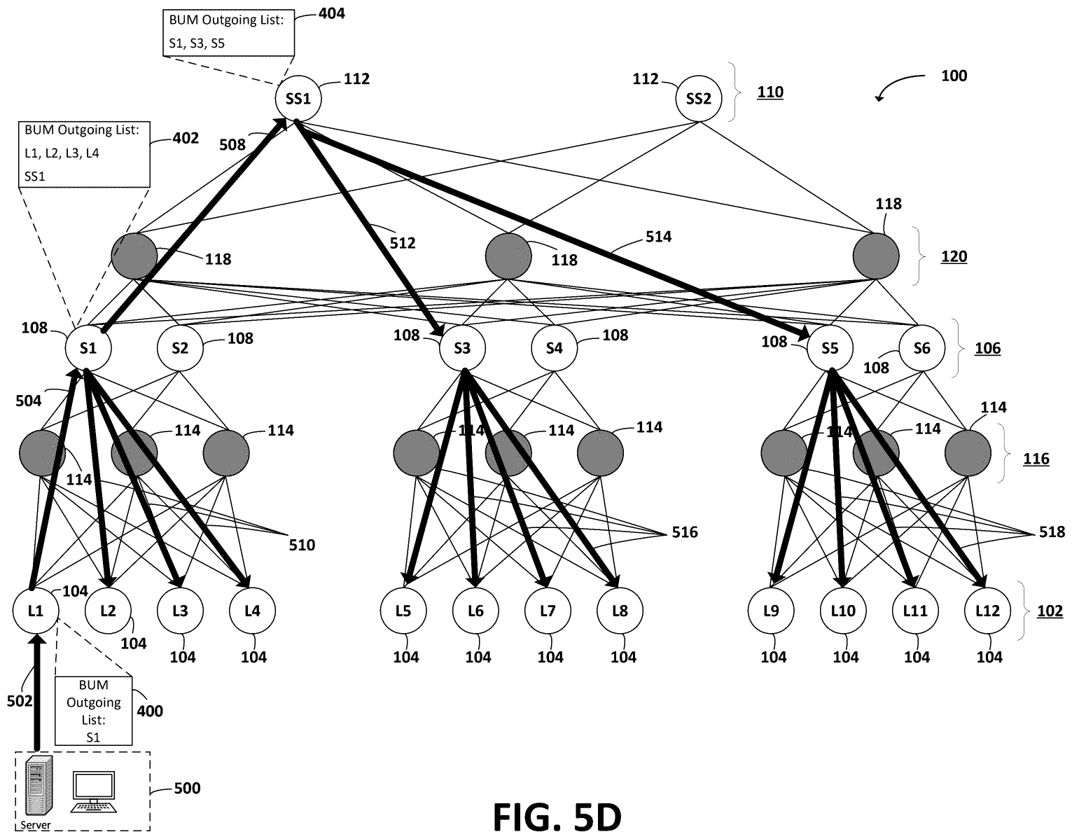

With leaf devices and spine devices provisioned and replication lists built as described, a non-limiting example of data plane operation for ingress replication of BUM traffic will be described next with reference to FIGS. 5A-C.

FIGS. 5A-D visually illustrates upstream and downstream replication of BUM traffic in a leaf-spine topology based on optimized ingress replication techniques described herein, according to some aspects of the present disclosure. As shown in FIG. 5A, network traffic may be received at one of leaf devices 104 (e.g., L1) from one or more end devices 500. One or more end devices 500 can include a server, a virtual machine, a working station such as a laptop or a desktop, a mobile phone, etc. The network traffic may be BUM traffic received on a BD over link 502 (which may be a wired and/or a wireless link).

L1, using replication list 400, sends one copy of the traffic to spine device S1 on link 504 (which may be a wired and/or a wireless link).

FIG. 5B illustrates that S1, upon receiving a copy of the BUM traffic on link 504, S1 sends a copy of the received traffic to a super spine device (SS1) on link 508. S1 also forwards the BUM traffic downstream to L2, L3, and L4 (while using split horizon to avoid sending the BUM traffic back to L1) on links 510. S1 completes this downstream propagation (flooding) and upstream replication using replication list 402.

FIG. 5C illustrates that SS1, upon receiving a copy of the BUM traffic, sends a copy of the BUM traffic to other zones (to designated spine devise at lower depth such as S3 in zone 202 and S5 in zone 204 on links 512 and 514, respectively). Similar to S1, SS1 may also use split horizon procedure to avoid sending the BUM traffic back to S1 in zone 200. SS1 complete this downstream propagation (flooding) per replication list 404.

Finally, FIG. 5D shows that each one of S3 and S5, as designated replicator for zone 202 and zone 204, propagates the received BUM traffic down to respective one(s) of leaf devices 104 on links 516 and 518, respectively.

Procedures described above ensure that ingress replication in multi-tier CLOS networks is optimized. Any failure and response thereto, remain the same as base EVPN procedures where network failure will be detected and new replicators may take over. Reprogramming may be needed across the network where the impact of a failure may occur.

Procedures described above optimize ingress replication because not all traffic need to replicated to all nodes/devices in the network. For instance, BUM traffic from L1 no longer needs to be sent to S2 in addition to S1 (and similarly to SS2 in addition to SS1). Similarly, downstream flooding can be more targeted and optimized (e.g., SS1 no longer sends downstream traffic to all spine devices in a given zone (e.g., S3 and S4 in zone 202, S5 and S6 in zone 204, etc.). Accordingly, the amount of data and traffic replication in a given leaf-spine topology can be drastically optimized particularly as the size and number of layers in a multi-layer topology increases (e.g., in MSDCs).

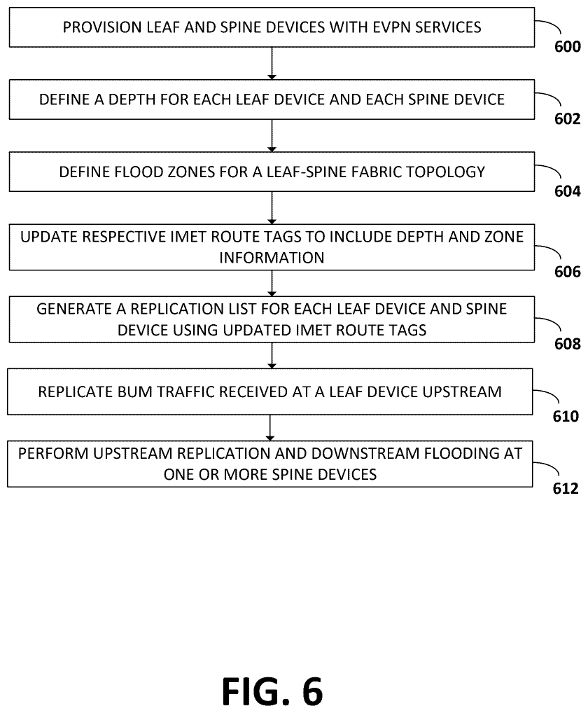

FIG. 6 illustrates an example method of optimized ingress replication, according to some aspects of the present disclosure.

At step 600, leaf devices and spine devices in a network may be provisioned with EVPN services, as described above with reference to FIG. 1. This provisioning may be performed manually, by each respective device such as each of leaf devices 104, spine devices 108, super spine devices 112 of topology 100, or by a controller such as controller 122 of FIG. 1.

At step 602, a depth may be defined for each provisioned leaf device and spine device. As described above, a depth ‘0’ may be defined for each of leaf devices 104 and a corresponding depth may be defined for each spine device depending on their respective position in a hierarchical structure of a leaf-spine fabric such as topology 100. For instance, a depth ‘1’ is assigned to spine devices 108 and a depth ‘2’ is assigned to super spine devices 112. This step may be performed manually, by each respective device such as each of leaf devices 104, spine devices 108, super spine devices 112 of topology 100, or by a controller such as controller 122 of FIG. 1

At step 604, flood zones such as zone 200, zone 202, and zone 204 are defined for a given hierarchical structure of a leaf-spine fabric such as topology 100. This step may be performed manually, by each respective device such as each of leaf devices 104, spine devices 108, super spine devices 112 of topology 100, or by a controller such as controller 122 of FIG. 1.

At step 606, at step 606, IMET route tag for each leaf device and spine device may be modified (updated) to include associated depth and zone information, as described with reference to FIG. 3B. This step may be performed manually, by each respective device such as each of leaf devices 104, spine devices 108, super spine devices 112 of topology 100, or by a controller such as controller 122 of FIG. 1.

At step 608, using the IMET route tag that includes depth and zone information, a replication list may be generated for each leaf device and a plurality of spine devices such as replication list 400, replication list 402, and replication list 404 as described above with reference to FIG. 4. The plurality of spine devices may be a subset of all spine devices in the network. This step may be performed manually, by each respective device such as each of leaf devices 104, spine devices 108, super spine devices 112 of topology 100, or by a controller such as controller 122 of FIG. 1.

At step 610, BUM traffic received at a given leaf device (e.g., L1) may be replicated upstream to a spine device according to the corresponding replication list for the leaf device at which the BUM traffic is received. This process may be performed as described above with reference to FIG. 5A.

At step 612, replicated traffic may further be replicated upstream and/or flooded downstream at one or more spine devices according to corresponding replication lists of the one or more spine devices. This process may be performed as described above with reference to FIGS. 5B-D.

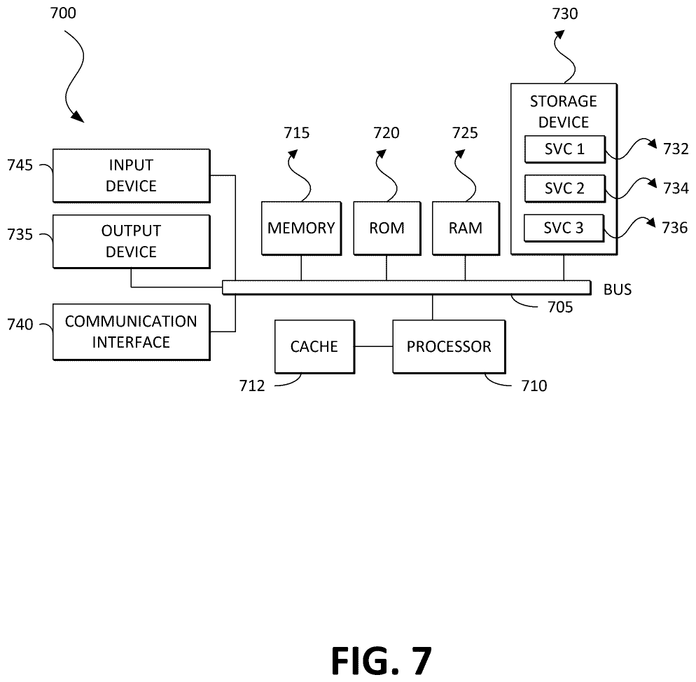

FIG. 7 shows an example of computing system according to some aspects of the present disclosure. Computing system 700 can be for example any computing device making up topology 100. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) such as processor 710 and connection 705 that couples various system components including system memory 715, such as read only memory (e.g., ROM 720) and random-access memory (e.g., RAM 725) to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 can essentially be a completely self-contained computing system, containing multiple cores or processors, a bus, memory controller, cache, etc. A multi-core processor can be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement and therefore the basic features here can easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
defining a corresponding depth for each leaf device and each spine device in a leaf-spine network fabric having a hierarchical structure;
defining one or more zones in the leaf-spine network fabric;
generating a corresponding replication list for each leaf device and one or more spine devices in the leaf-spine network fabric based at least in part of the corresponding depth and the one or more zones defined; and
performing ingress replication of network traffic received at a given leaf device using the corresponding replication list of the given leaf device and the corresponding replication list of at least one of the one or more spine devices.

2. The method of claim 1, wherein the leaf-spine network fabric is a CLOS network.

3. The method of claim 1, wherein performing the ingress replication includes upstream replication of the network traffic to a first spine device having the corresponding depth that is one level higher than the corresponding depth of the given leaf device, the first spine device being one of the one or more spine devices.

4. The method of claim 3, wherein the ingress replication includes downstream replication of the network traffic, by the first spine device, to one or more additional leaf devices that are in a same zone of the one or more zones as the given leaf device.

5. The method of claim 3, wherein,
the ingress replication includes upstream replication of the network traffic, by the first spine device, to a second spine device having the corresponding depth that is one level higher that the corresponding depth of the first spine device, and
the second spine device performs downstream replication of the network traffic to at least one third spine device with the corresponding depth one level lower that the corresponding depth of the second spine device, each of the at least one third spine device being in a different one of the one or more zones than the given leaf device.

6. The method of claim 5, wherein the upstream replication of the network traffic is repeated until the network traffic reaches at least one spine device with the corresponding depth having a highest value, with each receiving spine device performing a corresponding downstream replication to different zones of the one or more zones than a zone assigned to the given leaf device.

7. The method of claim 1, wherein the network traffic is Broadcast, Unknown Unicast, and Multicast (BUM) traffic.

8. A network device comprising:
one or more memories having computer-readable instructions stored therein; and
one or more processors configured to execute the computer-readable instructions to:
define a corresponding depth for each leaf device and each spine device in a leaf-spine network fabric having a hierarchical structure;
define one or more zones in the leaf-spine network fabric;
generate a corresponding replication list for each leaf device and one or more spine devices in the leaf-spine network fabric based at least in part of the corresponding depth and the one or more zones defined; and
perform ingress replication of network traffic received at a given leaf device using the corresponding replication list of the given leaf device and the corresponding replication list of at least one of the one or more spine devices.

9. The network device of claim 8, wherein the leaf-spine network fabric is a CLOS network.

10. The network device of claim 8, wherein the one or more processors are configured to execute the computer-readable instructions to perform the ingress replication by performing upstream replication of the network traffic to a first spine device having the corresponding depth that is one level higher than the corresponding depth of the given leaf device, the first spine device being one of the one or more spine devices.

11. The network device of claim 10, wherein the one or more processors are configured to execute the computer-readable instructions to perform the ingress replication by performing downstream replication of the network traffic, by the first spine device, to one or more additional leaf devices that are in a same zone of the one or more zones as the given leaf device.

12. The network device of claim 11, wherein,
the ingress replication includes upstream replication of the network traffic to a second spine device having the corresponding depth that is one level higher that the corresponding depth of the first spine device, and
the second spine device is configured to perform downstream replication of the network traffic to at least one third spine device with the corresponding depth one level lower that the corresponding depth of the second spine device, each of the at least one third spine device being in a different one of the one or more zones than the given leaf device.

13. The network device of claim 12, wherein the upstream replication of the network traffic is repeated until the network traffic reaches at least one spine device with the corresponding depth having a highest value, with each receiving spine device performing a corresponding downstream replication to different zones of the one or more zones than a zone assigned to the given leaf device.

14. The network device of claim 8, wherein the network traffic is Broadcast, Unknown Unicast, and Multicast (BUM) traffic.

15. One or more non-transitory computer-readable media comprising computer-readable instructions, which when executed by one or more processors, cause the one or more processors to:
define a corresponding depth for each leaf device and each spine device in a leaf-spine network fabric having a hierarchical structure;
define one or more zones in the leaf-spine network fabric;
generate a corresponding replication list for each leaf device and one or more spine devices in the leaf-spine network fabric based at least in part of the corresponding depth and the one or more zones defined; and
perform ingress replication of network traffic received at a given leaf device using the corresponding replication list of the given leaf device and the corresponding replication list of at least one of the one or more spine devices.

16. The one or more non-transitory computer-readable media of claim 15, wherein the leaf-spine network fabric is a CLOS network.

17. The one or more non-transitory computer-readable media of claim 15, wherein execution of the computer-readable instructions further cause the one or more processors to perform the ingress replication by performing upstream replication of the network traffic to a first spine device having the corresponding depth that is one level higher than the corresponding depth of the given leaf device, the first spine device being one of the one or more spine devices.

18. The one or more non-transitory computer-readable media of claim 17, wherein execution of the computer-readable instructions further cause the one or more processors to perform the ingress replication by performing downstream replication of the network traffic, by the first spine device, to one or more additional leaf devices that are in a same zone of the one or more zones as the given leaf device.

19. The one or more non-transitory computer-readable media of claim 18, wherein,
the ingress replication includes upstream replication of the network traffic to a second spine device having the corresponding depth that is one level higher that the corresponding depth of the first spine device, and
the second spine device is configured to perform downstream replication of the network traffic to at least one third spine device with the corresponding depth one level lower that the corresponding depth of the second spine device, each of the at least one third spine device being in a different one of the one or more zones than the given leaf device.

20. The one or more non-transitory computer-readable media of claim 19, wherein the upstream replication of the network traffic is repeated until the network traffic reaches at least one spine device with the corresponding depth having a highest value, with each receiving spine device performing a corresponding downstream replication to different zones of the one or more zones than a zone assigned to the given leaf device.
